(19) United States
(12) Patent Application Publication
(10) Pub. No.: US 2025/0196929 A1
(43) Pub. Date: Jun. 19, 2025

(54) RECREATIONAL VEHICLE AND ROOFING ASSEMBLY THEREOF

(71) Applicant: FOREST RIVER, INC., Elkhart, IN (US)

(72) Inventors: Lionel Garza, Warsaw, IN (US); Cody Schade, Edwardsburg, MI (US)

(21) Appl. No.: 18/982,364

(22) Filed: Dec. 16, 2024

Related U.S. Application Data
(60) Provisional application No. 63/611,402, filed on Dec. 18, 2023.

(51) Int. Cl. B62D 25/06; B60J 5/04; B60P 3/32; B60P 3/34

(52) U.S. Cl. CPC B62D 25/06; B60P 3/32; B60J 5/04; B60P 3/343

(57) ABSTRACT

A recreational travel trailer includes a frame and a body. The body includes a first side wall located along a first side and a second side wall located along a second side. A roof assembly is coupled to the body and includes a rafter assembly, a first rail member and a second rail member. The first rail member is coupled to the first side wall and the second rail member is coupled to the second side wall. The rafter assembly includes a top support member, a first side support member, a second side support member, and a bottom support member, where the first side support member and the second side support member are disposed between the top support member and bottom support member. The roof assembly slopes downwardly from the first side to the second side.

### RELATED APPLICATIONS

This application claims the benefit of U.S. Provisional Patent Application Ser. No. 63/611,402, filed Dec. 18, 2023, the disclosure of which is hereby incorporated by reference in its entirety.

### FIELD OF THE DISCLOSURE

The present disclosure relates to a recreational vehicle such as a travel trailer or fifth wheel travel trailer, and more particularly to a roof assembly thereof.

### BACKGROUND

Recreational vehicles provide individuals with spacious, comfortable and transportable lodging. For example, a typical fifth wheel travel trailer includes a housing member having a multi-level interior living space formed therein, a multi-level chassis adapted to support the housing member, and a carriage member having a plurality of wheels interposed between the chassis and a supporting surface so as to enable the trailer to travel on the supporting surface. Furthermore, the typical fifth wheel trailer is adapted to detachably mount to a towing vehicle so that a front end of the trailer extends beyond the load bearing rear wheels of the towing vehicle to enable the towing vehicle to essentially act as a fifth wheel.

Since fifth wheel trailers are currently available with lengths as great as forty-five feet (and possibly longer) and pop-out sections that provide the housing member with increased width, their interior living spaces are able to resemble that of a nicely appointed home. For example, a fifth wheel travel trailer can include a large kitchen, a large bathroom, a large bedroom, and a large living area. Moreover, these trailers typically include multiple water storage tanks for supplying hot and cold water as well as for storing wastewater, wiring for distributing electrical power and a central heating/ventilation/air conditioning (HVAC) system for providing desirable environmental conditions within the interior living space.

### SUMMARY

In one implementation of the present disclosure, a recreational travel trailer includes a frame; one or more wheels for supporting the frame on a ground surface; a body supported by the frame, the body includes at least a first side wall located along a first side of the frame and a second side wall located along a second side of the frame, the first side being opposite the second side; a roof assembly coupled to the body and extending from the first side to the second side, the roof assembly includes at least one rafter assembly; and a first rail member and a second rail member, the first rail member coupled to the first side wall and the second rail member coupled to the second side wall; wherein, the at least one rafter assembly includes a top support member, a first side support member, a second side support member, and a bottom support member, where the first side support member and the second side support member are disposed between the top support member and bottom support member; wherein, the first side support member includes a greater height than the second side support member such that the roof assembly includes a descending slope from the first side to the second side.

In one example of this implementation, the first rail member and the second rail member include substantially the same length as the respective first side wall and second side wall. In a second example, the first rail member and the second rail member include substantially the same width as the respective first side wall and second side wall. In a third example, the roof assembly extends past the first side wall or second side wall to form an overhang portion. In a fourth example, the at least one rafter assembly includes at least one intermediate support member coupled between the top support member and the bottom support member, the at least one intermediate support member being located between the first side support member and the second side support member.

In a fifth example, the at least one rafter assembly includes a plurality of intermediate support members coupled between the top support member and the bottom support member, the plurality of intermediate support members being located between the first side support member and the second side support member, where each of the plurality of intermediate support members include a different height from the other of the plurality of intermediate support members. In a sixth example, the plurality of intermediate support members includes a first intermediate support member and a second intermediate support member, the first intermediate support member being located closer to the first side than the second intermediate support member, where the first intermediate support member has a greater height than the second intermediate support member.

In a seventh example, the bottom support member includes at least a first notch and a second notch. In an eighth example, the first rail member is located within the first notch and the second rail member is located within the second notch. In a ninth example, the first side wall is directly aligned with the first notch, the first rail member being located between the first notch and the first side wall; the second side wall is directly aligned with the second notch, the second rail member being located between the second notch and the second side wall.

In a tenth example, the roof assembly includes a roof member coupled to the top support member of the at least one rafter assembly. In another example, the body includes a front wall and a rear wall, where the at least one rafter assembly includes a plurality of rafter assemblies; wherein, each of the plurality of rafter assemblies are spaced from one another between the front wall and the rear wall. In yet another example, the first side wall forms an opening that is selectively opened or closed by a door assembly. In a further example, an awning is coupled to the first side wall.

In a second implementation of the present disclosure, a roof assembly of a recreational travel trailer includes a rafter assembly having a first side and a second side, the rafter assembly includes a top support member, a first side support member located on the first side, a second side support member located on the second side, a bottom support member, and at least one intermediate support member spaced between the first side support member and the second side support member, where the first side support member and the second side support member are disposed between the top support member and bottom support member; a first rail member and a second rail member, the first rail member and the second rail member coupled to the bottom support member; wherein, the first side support member includes a greater height than the second side support member such that the roof assembly slopes downwardly from the first side to the second side.

In a first example, the bottom support member includes at least a first notch and a second notch. In a second example, the first rail member is located within the first notch and the second rail member is located within the second notch. In a third example, the at least one intermediate support member is coupled between the top support member and the bottom support member. In a fourth example, the roof assembly includes a roof member coupled to the top support member of the rafter assembly.

In a further implementation of the present disclosure, a recreational travel trailer includes a frame; one or more wheels configured to support the frame on a ground surface; a body supported by the frame, the body includes a front wall, a rear wall, a first side wall located along a first side of the frame and a second side wall located along a second side of the frame, the first side being opposite the second side; a door assembly coupled to the first side wall; a roof assembly coupled to the body and sloping downwardly from the first side to the second side, the roof assembly includes at least one rafter assembly including a top support member, a first side support member, a second side support member, and a bottom support member, where the first side support member and the second side support member are disposed between the top support member and bottom support member; and a first rail member and a second rail member, the first rail member coupled to the first side wall and the second rail member coupled to the second side wall; wherein, the first side support member includes a greater height than the second side support member; wherein, the bottom support member includes at least a first notch and a second notch, the first rail member being located within the first notch and the second rail member being located within the second notch.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 is a side view of a recreational vehicle;

FIG. 2 is a perspective view of a recreational vehicle with an angled roof assembly;

FIG. 3 is a schematic of an arrangement of views of the recreational vehicle of FIG. 2;

FIG. 4 is a schematic of a front view of the recreational vehicle of FIG. 2;

FIG. 4A is a schematic of detail A in FIG. 4;

FIG. 4B is a schematic of detail B in FIG. 4;

FIG. 5A is a schematic of a portion of an angled roof assembly;

FIG. 5B is a perspective view of an interior side of an angled roof assembly including the portion of FIG. 5A;

FIG. 6 is a perspective view of an exterior side of an angled roof assembly;

FIG. 7 is a schematic of an angled roof assembly;

FIG. 8 is a schematic of a front view of a conventional recreational vehicle;

FIG. 8A is a schematic of detail C in FIG. 8; and

FIG. 8B is a schematic of detail D in FIG. 8.

Corresponding reference numerals are used to indicate corresponding parts throughout the several views.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

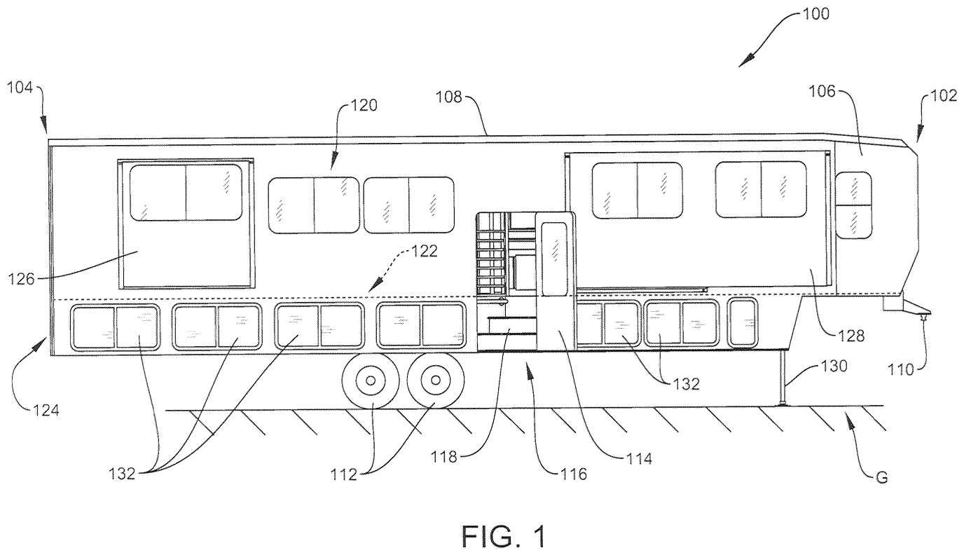

Referring to FIG. 1, an implementation of a recreational vehicle in the form of a fifth wheel travel trailer 100 is illustrated. While a fifth wheel is shown, the present disclosure is not limited to fifth wheel travel trailers. Any type of travel trailer may be relevant to the present disclosure. In any event, the trailer 100 may include a front end 102 and a rear end 104. For instance, an interior floor 122 of the trailer 100 may lie along a substantially horizontal plane between the front 102 and rear 104 thereof. The single-level trailer 100 may be formed as a body 106 supported by a frame assembly or chassis (not shown). The frame assembly or chassis may be a drop frame assembly or a straight frame assembly. The body 106 and frame assembly may be further supported by one or more wheels 112.

The body 106 may include an overhead roof 108 as shown in FIG. 1. Further, a hitch 110 may be located at the front end 102 of the trailer for coupling to a towing motorized or powered vehicle (not shown). When the trailer 100 is disconnected from the towing vehicle, a support member 130 or landing gear may be provided to support the front end 102 thereof.

The body 106 may include skirting (not shown). In other embodiments, the trailer may not include any skirting.

A door 114 may be coupled to the body 106 to allow access between the interior of the trailer 100 and outside thereof. The door 114, when opened, allows access to an entryway 116 which may be accessed by a set of steps 118 between the ground, G, and a living area 120 of the trailer 100. In one embodiment, the entryway 116 may have a width greater than the typical 30″ found on some multi-level fifth wheel trailers. For instance, the passageway 116 may have a width between 30-40 inches. In a further example, the width may be between 32-38 inches. In yet a further example, the width may be approximately 36 inches. The present disclosure is not intended to be limited to any type of width of the entryway 116.

The trailer 100 may include a first slide out 126 and a second slide out 128. The slide outs, when configured in their deployed positions, allow the single level living area 120 to increase in living space as the side wall of the body 106 moves outwardly a predetermined distance. While the trailer 100 of FIG. 1 includes a pair of slide outs, this is not intended to be limiting. The trailer 100 may include any number of slide outs for purposes of the present disclosure.

The travel trailer may include a height defined between the floor 122 and ceiling. In some embodiments, the height may be approximately the same throughout, whereas in other embodiments, the height may vary between the front 102 and rear 104. In FIG. 1, a first height, H₁, at the rear 104 of the trailer 100 may be approximately, if not exactly, the same as a second height, H₂, at the front 102 thereof. For example, the heights may be up to 84 inches. Conventional multi-level fifth wheel travel trailers having varying heights throughout the interior living spaces depending upon the location therein. For instance, a conventional multi-level fifth wheel may have heights that vary between 75 inches and 105 inches, where the less headroom is normally found in those living spaces that are elevated at the front and/or rear of the trailer.

The floor level 122 may separate the living space 120 of the trailer 100 from a storage compartment or basement 124. The storage compartment 124 may be accessed by any one of a plurality of storage doors 132. The storage compartment 124 of the travel trailer 100 of FIG. 1 may be individual compartments or a full pass-through storage space that runs continuously (e.g., uninterrupted) from the rear end 104 of the trailer 100 to a location towards the front end 102 thereof. In FIG. 1, for example, the storage compartment 124 may be a continuous space defined between point A at the rear 104 and point B towards the front 102. The storage compartment 124 may be formed of a single piece of composite material which can reduce the overall cost of the trailer 100. In other embodiments, the storage compartment 124 may be formed of other material besides composite.

In many conventional recreational vehicles, a roof assembly is sloped or angled to both sides of the vehicle to induce water, debris, and the like to flow off either side thereof. Many conventional recreational vehicles include gutters disposed adjacent to the roof assembly on both sides of the vehicle to collect water, debris, and the like. The gutters are oriented to move the water, debris, and the like towards the front or rear of the vehicle where the water, debris, and the like are discharged.

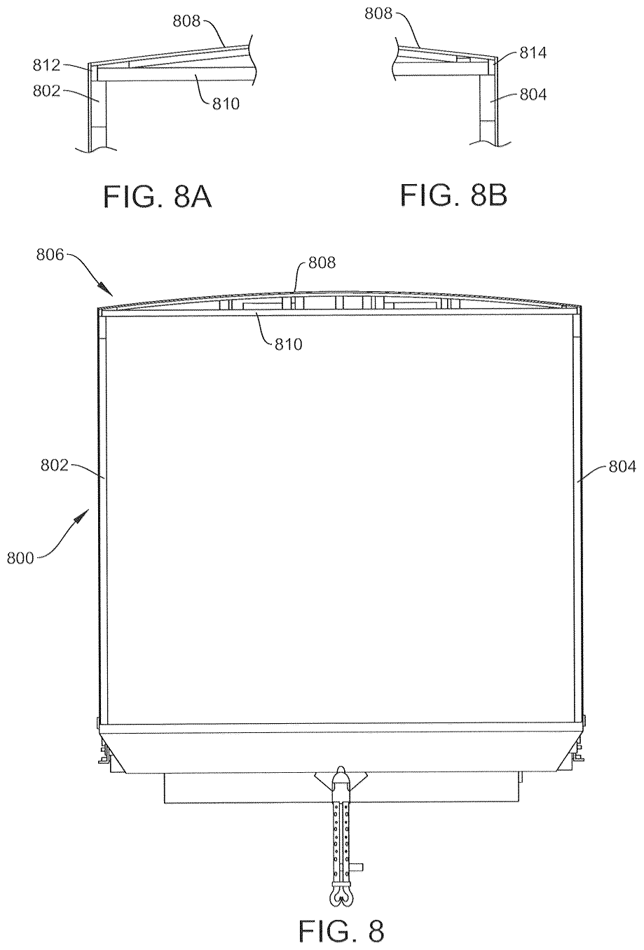

Referring to FIG. 8 of the present disclosure, one example of a recreational vehicle 800 is shown. The recreational vehicle 800 includes a body partially formed by a first side wall 802 and a second side wall 804. A roof assembly 806 is attached to the first side wall 802 and second side wall 804. In particular, as shown in FIGS. 8, 8A, and 8B, the roof assembly 806 includes a top support member 808 and a bottom support member 810. The top support member 808 has a curvature with a peak located proximate the middle or center of the top support member 808. The remainder of the top support member 808 is shown curving downward to either side of the vehicle 800 to allow water, debris and the like to flow off along a first direction 816 or a second direction 818 to both sides of the vehicle 800.

As best shown in FIGS. 8A and 8B, the first side wall 802 includes a first rail member 812 connected thereto and the second side wall 804 includes a second rail member 814 connected thereto. In FIG. 8A, the first rail member 812 is supported and connected directly to an upper surface of the first side wall 802. Moreover, a portion of the bottom support member 810 is also partially supported along the upper surface of the first side wall 802. As shown, the portion of the bottom support member 810 may be directly in contact with the first rail member 812 and the first side wall 802. In the same way, in FIG. 8B, the second rail member 814 is supported and connected directly to an upper surface of the second side wall 804. Moreover, a portion of the bottom support member 810 is also partially supported along the upper surface of the second side wall 804. As shown, the portion of the bottom support member 810 may be directly in contact with the second rail member 814 and the second side wall 804. Thus, the bottom support member 810 of the roof assembly is directly in contact with the first side wall 802 and the second side wall 804.

While the roof assembly of FIG. 8 is designed to move water, debris and the like off of the roof assembly, at least a portion of the water, debris and the like is moved and released on the door side of the trailer. This is generally the area where users of the recreational vehicle camp, sit, walk, and otherwise spend the majority of their time when at the vehicle. Often when it rains, the volume of rain is too much for the gutters to hold. The rain therefore can overflow the gutters and fall to the underlying ground. This can create a muddy area surrounding the door side of the vehicle.

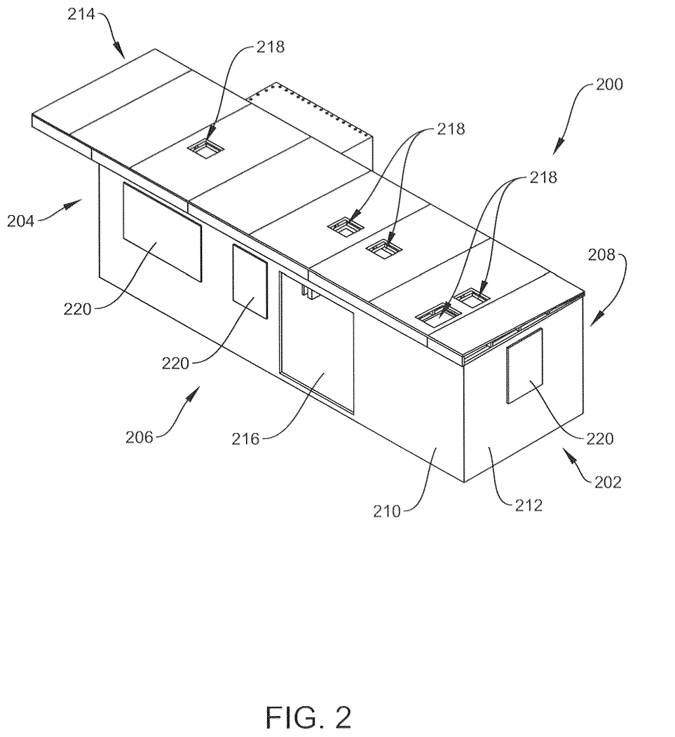

To provide improvements over some conventional recreational vehicles, an alternative implementation of a recreational vehicle (e.g., a recreational travel trailer) is illustrated in FIGS. 2-7. In FIG. 2, for example, a recreational vehicle in the form of a travel trailer 200 is shown. The travel trailer 200 may include a body or frame 210 supported by a ground-engaging mechanism such as one or more wheels (not shown). The body may include a front wall, rear wall, side walls, a bottom wall or floor, and a top wall or ceiling. Only a portion of the travel trailer 200 is depicted in FIG. 2, but the travel trailer 200 may be arranged to have a front side 202, a rear side 204, a first side 206, and a second side 208. A body or frame 212 may be arranged at the front side 206 of the travel trailer 200, and a door assembly 216 may be located on the first side 206 thereof. Although not shown, the travel trailer 200 may include a hitch assembly located on the front side 202 or rear side 204 for being towed by a motorized or powered vehicle.

In some implementations, the door assembly 216 may include one or more doors pivotally or hingedly coupled to the body 212. In other implementations, the door assembly 216 may include one or more doors that may be slidably coupled to the body 210. In either case, the door assembly may provide access to an interior of the travel trailer 200. One or more steps (not shown) may allow access to and from the interior of the travel trailer 200, if necessary. As shown, one or more window openings 220 may be formed in the body 210 as well. In some implementations, one or more slide out assemblies may be incorporated into the body 210.

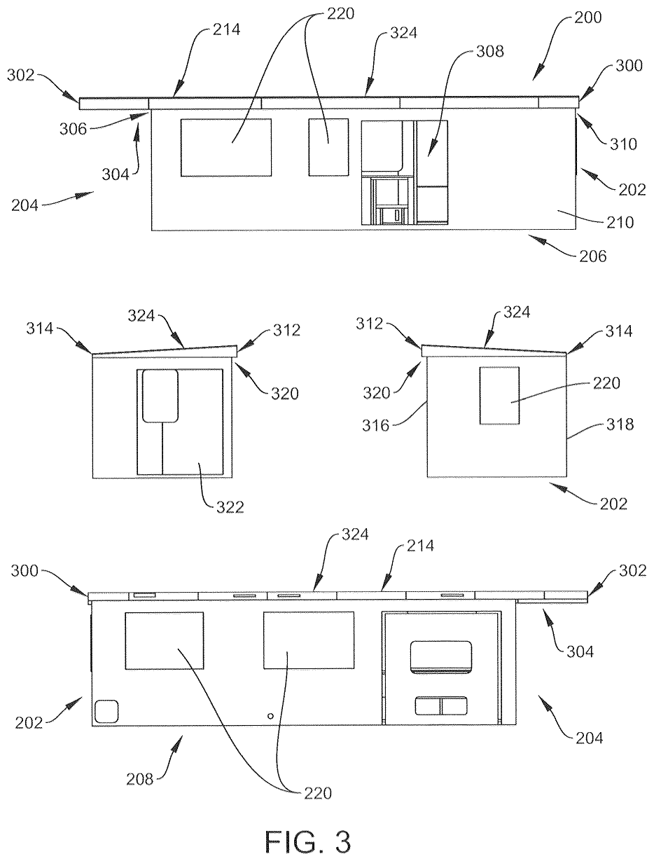

The travel trailer 200 may also include a roof assembly 214 as shown. A plurality of openings 218 may be formed in the roof assembly 214 for vents, air conditioning units, sky lights, etc. The roof assembly 214 of the travel trailer 200 is structured to be angled towards the second side 208 of the travel trailer 200. In FIG. 3, for example, the first side 206 (i.e., door side view), the second side 208 (i.e., off door side view), the front side 202 and the rear side 204 are shown. In the front view, i.e., the front side 202 of the travel trailer 200, the roof assembly 214 includes a first side roof end 312 located at the first side 206 and a second side roof end 314 located at the second end 208. As shown, the first side roof end 312 has a greater height than the second side roof end 314.

In one implementation, the roof assembly 214 includes a roof top surface 324 that angles downwardly from the first side roof end 312 to the second side roof end 314. In some implementations, the roof top surface 324 is angled downwardly from the first side roof end 312 to the second side roof end 314 at a constant slope. In other implementations, the roof top surface 324 is angled downwardly from the first side roof end 312 to the second side roof end 314 at a varying slope. With the sloped or angled roof assembly, water, debris, etc. is diverted or biased towards the second side 208. As a result, water is diverted away from the door assembly and first side 206.

As also shown in FIG. 3, the roof assembly 214 includes a front roof end 300 and a rear roof end 302. The front roof end 300 is located in close proximity and/or adjacent to a front body end 310. In other words, the body 212 is defined at the front body end 310. The roof assembly 214 may extend or overhang the first body end 310. At the opposite end, the rear roof end 302 extends beyond a rear body end 306 and forms a rear overhang portion 304. A rear door assembly 322 may be located at the rear side 204 of the travel trailer 200 as shown.

The door assembly 216 of FIG. 2 may be opened or closed to either allow access to an interior of the travel trailer 200 via a door opening 308 or prevent access to the interior.

As shown in the front and rear views of FIG. 3, the first side 206 of the travel trailer 200 is formed by a first side body end 316. A side wall (to be described below) may form part of the first side body end 316. The first side body end 316 is generally intended to illustrate the entirety of the body 210 that is formed at the first end 206. In a similar manner, the second side 208 of the travel trailer 200 is formed by a second side body end 318. An opposite side wall may form part of the second side body end 318. Like the first side body end 316, the second side body end 318 is generally intended to illustrate the entirety of the body 210 that is formed at the second end 208. The roof assembly 214 is shown to partially extend past the first side body end 316 to form a first side overhang 320. In particularly, the first side roof end 312 is offset from the first side body 316 to form the first side overhang 320. In this manner, the highest point of the roof assembly 214 is located at the first side roof end 312, which forms the overhang and further facilitates the diversion of water, debris, etc. towards the second side 208 of the travel trailer 200.

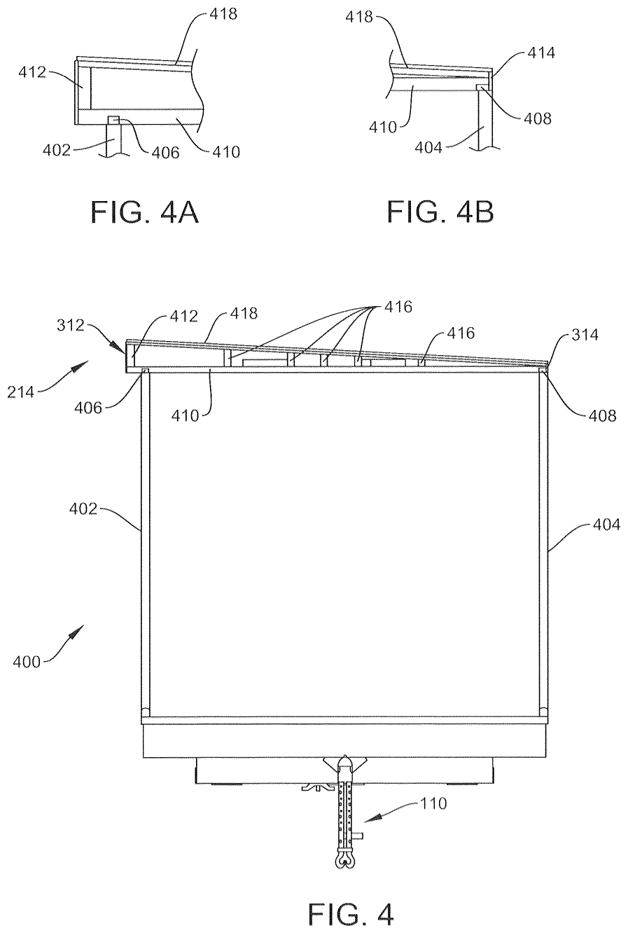

Referring to FIG. 4, an implementation of a travel trailer 400 is shown. The travel trailer 400 includes a first side wall 402 and a second side wall 404. Another implementation of a roof assembly 214 is assembled to the travel trailer 400. To do so, the first side wall 402 includes a first rail member 406 and the second side wall 404 includes a second rail member 408. The first rail member 406 and the second rail member 408 may have the same width as the first and second side walls 402, 404, respectively. In other implementations, the first rail member 406 and the second rail member 408 may include widths that are less than the widths of the first and second side walls 402, 404.

The roof assembly 214 may be formed or supported by a plurality of rafter assemblies. In FIG. 4, each rafter assembly may be formed by a bottom support member 410, a first side support member 412, a second side support member 414, a top support member 418, and one or more intermediate support members 416. The one or more intermediate support members may have differing heights based on their location between the top support member 418 and the bottom support member 410. Moreover, the one or more intermediate support members may be spaced from one another and located between the first side support member 412 and the second side support member 414. As shown in FIG. 4, the top support member 418 may be angled downwardly from the first side support member 412 to the second side support member 414.

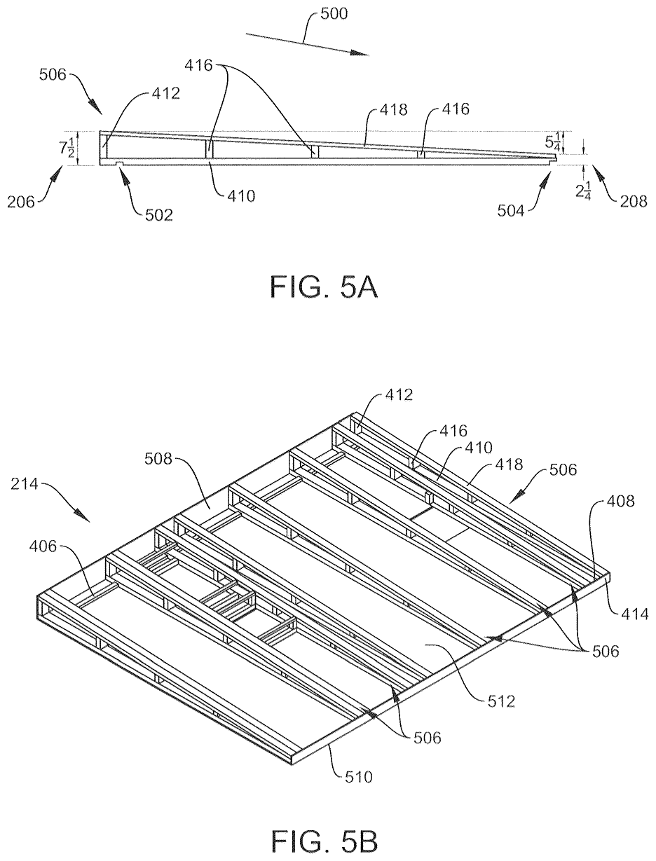

In one implementation, the first side support member 412 may have a height that is greater than the second side support member 414. In another implementation, the first side support member 412 may have a height that is two times greater than the second side support member 414. In a further implementation, the first side support member 412 may have a height that is three times greater than the second side support member 414. In yet another implementation, the first side support member 412 may have a height that is at least two times greater than the second side support member 414. In yet a further implementation, the first side support member 412 may have a height that is between two and ten times greater than the second side support member 414. The greater height of the first side support member 412 relative to the height of the second side support member 414 facilitates the diversion of water, debris, and the like to flow along direction 500 (FIG. 5) from the first side 206 to the second side 208 of the travel trailer 400.

In FIGS. 4A, 4B, 5A, and 5B, the bottom support member 410 may include one or more notches formed therein. As shown in FIG. 5A, the bottom support member 410 may include a first notch 502 and a second notch 504. The first notch 502 may be located generally towards the first side 206 and the second notch 504 may be located generally towards the second side 208. In one implementation, the second notch 504 may be formed at the second side roof end 314.

The roof assembly of FIGS. 5A and 5B may be formed by a plurality of rafter assemblies 506, of which the rafter assembly of FIG. 4 is illustrated as an example of one of the plurality of raft assemblies. The roof assembly may include a first side end member 508, a second side end member 510, and at least one roof member 512. In some implementations, a plurality of roof members 512 may be coupled to the plurality of rafter assemblies 506 to form the roof assembly 214.

In FIG. 4A, the first rail member 406 may be disposed within the first notch 502 of the bottom support member 410. Similarly, the second rail member 408 may be disposed within the second notch 504 of the bottom support member 410. In this way, each of the plurality of rafter assemblies 506 may be coupled directly to the first and second rail members 406, 408. A fastener such as a screw, bolt, nut, washer, staple, adhesive, welding, etc. may be used for coupling the plurality of rafter assemblies 506 to the first and second rail members 406, 408. In other implementations, each rafter assembly 506 may be press-fit, snapped, latched, or coupled in another manner to each of the first and second rail members 406, 408.

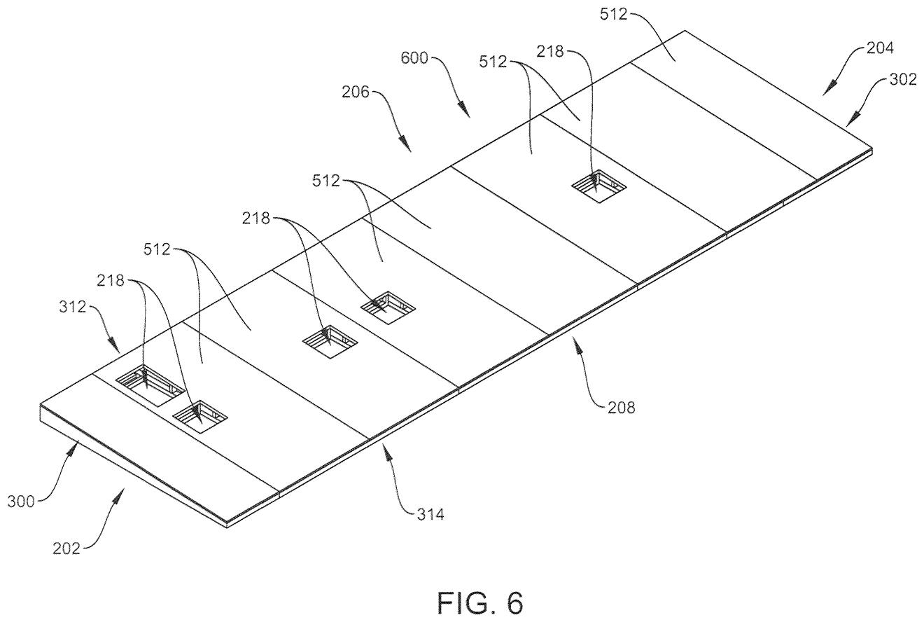

The roof assembly 214 is further shown in FIG. 6 from a top view 600 thereof. As shown, the roof assembly 214 is angled downwardly from the first side 206 to the second side 208. The roof assembly 214 is continuous from the front roof end 300 to the rear roof end 302.

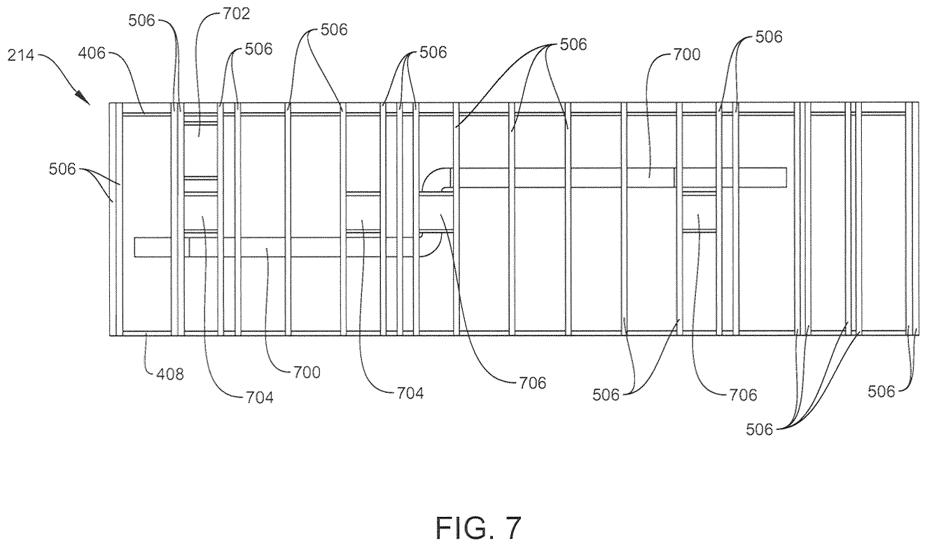

In the illustration of FIG. 7, one implementation of a roof assembly is shown. In this implementation, the plurality of rafter assemblies 506 are shown distributed between the front side 202 to the rear side 204 of the travel trailer. The first rail member 406 and second rail member 408 are also shown. In FIG. 7, the travel trailer may include one or more vents 704 formed in the roof assembly 214. In addition, one or more sky lights 702 may be incorporated in the roof assembly 214. Further, one or more air conditioning units or other appliances may be built into or incorporated in the roof assembly 214. One or more ducts 700 may connect between the various air conditioning units (A/C) 706 and vents 704.

Although not shown, in some implementations, a travel trailer may include one or more awnings that may be movable between a stowed configuration and a deployed configuration. The one or more awnings may be coupled to the first side wall 402 and at a location below the first side overhang 320. Due to the slant or angle of the roof assembly 214, water and other debris is diverted away from the first side 206 and thus away from the one or more awnings. As such, water does not drip or flow onto the awnings when it is raining or snowing. Further, on hot and/or humid days, condensation from the air conditioning unit(s) is diverted away from the first side 206 of the travel trailer and towards the non-door side thereof.

In yet another alternative implementation, a travel trailer may include a roof assembly 214 that does not have a first side overhang 320. Instead, the first side roof end 312 may align approximately with the first side body end 316 without overhanging the first side 206 (i.e., door side) of the travel trailer 200.

One of the advantages of the travel trailer implementation in FIGS. 2-7 is the manner in which the roof assembly 214 is supported by the side walls. Specifically, as shown in FIG. 4, the first rail member 406 is disposed substantially or entirely within the first notch 502 of each rafter assembly 506, and the second rail member 408 is disposed substantially or entirely within the second notch 504 of each rafter assembly 506. With the first and second rail members 406, 408 forming a part of each side wall 402, 404, each rafter assembly 506 is supported by the first and second side walls. Unlike the implementation of FIG. 8, where a portion of the bottom support member 810 is in contact with each side wall, in the implementation of FIG. 4 the notched bottom support member 410 is entirely supported by the rail members.

Moreover, the coupling of the first and second notches of each rafter assembly with the respective first and second rail members 406, 408 also helps during the assembly process. Specifically, the coupling of the rail members 406, 408 in the corresponding notches 502, 504 helps align each of the plurality of rafter assemblies 506 with one another along the longitudinal direction of the travel trailer between the front side 202 and the rear side 204. The alignment helps maintain sufficient support to the roof assembly 214 as it is assembled to the body 210 of the travel trailer 200.

While exemplary embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A recreational travel trailer, comprising:
a frame;
one or more wheels for supporting the frame on a ground surface;
a body supported by the frame, the body comprising at least a first side wall located along a first side of the frame and a second side wall located along a second side of the frame, the first side being opposite the second side;
a roof assembly coupled to the body and extending from the first side to the second side, the roof assembly comprising at least one rafter assembly; and
a first rail member and a second rail member, the first rail member coupled to the first side wall and the second rail member coupled to the second side wall;
wherein, the at least one rafter assembly comprises a top support member, a first side support member, a second side support member, and a bottom support member, where the first side support member and the second side support member are disposed between the top support member and bottom support member;
wherein, the first side support member comprises a greater height than the second side support member such that the roof assembly comprises a descending slope from the first side to the second side.

2. The recreational travel trailer of claim 1, wherein the first rail member and the second rail member comprise substantially the same length as the respective first side wall and second side wall.

3. The recreational travel trailer of claim 1, wherein the first rail member and the second rail member comprise substantially the same width as the respective first side wall and second side wall.

4. The recreational travel trailer of claim 1, wherein the roof assembly extends past the first side wall or second side wall to form an overhang portion.

5. The recreational travel trailer of claim 1, wherein the at least one rafter assembly comprises at least one intermediate support member coupled between the top support member and the bottom support member, the at least one intermediate support member being located between the first side support member and the second side support member.

6. The recreational travel trailer of claim 1, wherein the at least one rafter assembly comprises a plurality of intermediate support members coupled between the top support member and the bottom support member, the plurality of intermediate support members being located between the first side support member and the second side support member, where each of the plurality of intermediate support members comprise a different height from the other of the plurality of intermediate support members.

7. The recreational travel trailer of claim 6, wherein the plurality of intermediate support members comprises a first intermediate support member and a second intermediate support member, the first intermediate support member being located closer to the first side than the second intermediate support member, where the first intermediate support member has a greater height than the second intermediate support member.

8. The recreational travel trailer of claim 1, wherein the bottom support member comprises at least a first notch and a second notch.

9. The recreational travel trailer of claim 8, wherein the first rail member is located within the first notch and the second rail member is located within the second notch.

10. The recreational travel trailer of claim 1, wherein:
the first side wall is directly aligned with the first notch, the first rail member being located between the first notch and the first side wall;
the second side wall is directly aligned with the second notch, the second rail member being located between the second notch and the second side wall.

11. The recreational travel trailer of claim 1, wherein the roof assembly comprises a roof member coupled to the top support member of the at least one rafter assembly.

12. The recreational travel trailer of claim 1, wherein the body includes a front wall and a rear wall, where the at least one rafter assembly comprises a plurality of rafter assemblies;
wherein, each of the plurality of rafter assemblies are spaced from one another between the front wall and the rear wall.

13. The recreational travel trailer of claim 1, wherein the first side wall forms an opening that is selectively opened or closed by a door assembly.

14. The recreational travel trailer of claim 13, further comprising an awning coupled to the first side wall.

15. A roof assembly of a recreational travel trailer, comprising:
a rafter assembly having a first side and a second side, the rafter assembly comprising a top support member, a first side support member located on the first side, a second side support member located on the second side, a bottom support member, and at least one intermediate support member spaced between the first side support member and the second side support member, where the first side support member and the second side support member are disposed between the top support member and bottom support member;
a first rail member and a second rail member, the first rail member and the second rail member coupled to the bottom support member;
wherein, the first side support member comprises a greater height than the second side support member such that the roof assembly slopes downwardly from the first side to the second side.

16. The roof assembly of claim 15, wherein the bottom support member comprises at least a first notch and a second notch.

17. The roof assembly of claim 16, wherein the first rail member is located within the first notch and the second rail member is located within the second notch.

18. The roof assembly of claim 16, wherein the at least one intermediate support member is coupled between the top support member and the bottom support member.

19. The roof assembly of claim 15, wherein the roof assembly comprises a roof member coupled to the top support member of the rafter assembly.

20. A recreational travel trailer, comprising:
a frame;
one or more wheels configured to support the frame on a ground surface;
a body supported by the frame, the body comprising a front wall, a rear wall, a first side wall located along a first side of the frame and a second side wall located along a second side of the frame, the first side being opposite the second side;
a door assembly coupled to the first side wall;
a roof assembly coupled to the body and sloping downwardly from the first side to the second side, the roof assembly comprising at least one rafter assembly including a top support member, a first side support member, a second side support member, and a bottom support member, where the first side support member and the second side support member are disposed between the top support member and bottom support member; and
a first rail member and a second rail member, the first rail member coupled to the first side wall and the second rail member coupled to the second side wall;
wherein, the first side support member comprises a greater height than the second side support member;
wherein, the bottom support member comprises at least a first notch and a second notch, the first rail member being located within the first notch and the second rail member being located within the second notch.
